(19) United States
(12) Patent Application Publication
(10) Pub. No.: US 2026/0289390 A1
(43) Pub. Date: Sep. 24, 2026

(54) PARAMETER REHYDRATION FOR MACHINE LEARNING SYSTEMS

(71) Applicant: QUALCOMM Incorporated, San Diego, CA (US)

(72) Inventors: Nirmit Nayan ZINZUWADIA, Markham (CA); Brandon LIEBMAN, Toronto (CA); Prathamesh Prakash PRABHUDESAI, North York (CA); Shiu Wai HUI, Richmond Hill (CA); Jian WANG, Thornhill (CA); Veluppillai ARULESAN, Concord (CA); Jeffrey Baginsky GEHLHAAR, San Diego, CA (US)

(21) Appl. No.: 19/086,006

(22) Filed: Mar. 20, 2025

(51) Int. Cl. G06N 20/00; G06N 3/082

(52) U.S. Cl. CPC G06N 20/00; G06N 3/082

(57) ABSTRACT

Systems and techniques are described herein for modifying a binary file. For instance, a method for modifying a binary file is provided. The method may include obtaining a plurality of update weights to apply to respective update layers of a plurality of update layers of an executable file representative of a machine-learning model; extracting a plurality of weights from the executable file; dividing the plurality of weights into a plurality of chunks; identifying a respective chunk offset relative to a reference point in the executable file for each chunk of the plurality of chunks; transforming update weights of each update layer of the plurality of update layers to generate respective transformed weights; chunking the respective transformed weights to generate transformed chunks for each update layer.

### TECHNICAL FIELD

The present disclosure generally relates to machine learning systems or models. For example, aspects of the present disclosure include systems and techniques for providing parameter rehydration for machine learning systems or models.

### BACKGROUND

Machine-learning systems (also referred to as machine-learning models) may be trained to perform various tasks (e.g., generating an output based on an input), such as making predictions, classification, object detection, responding to queries, summarizing, etc. Machine-learning models may be implemented as binary files. For example, a binary file that represents a machine-learning model may be generated. The binary file may be executed by a software stack. In executing the binary file, the software stack may run the machine-learning model.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for modifying a binary file. According to at least one example, a method is provided for modifying a binary file. The method includes: obtaining a plurality of update weights to apply to respective update layers of a plurality of update layers of an executable file representative of a machine-learning model; extracting a plurality of weights from the executable file; dividing the plurality of weights into a plurality of chunks; identifying a respective chunk offset relative to a reference point in the executable file for each chunk of the plurality of chunks; transforming update weights of each update layer of the plurality of update layers to generate respective transformed weights; chunking the respective transformed weights to generate transformed chunks for each update layer; identifying an update offset relative to the reference point in the executable file for each transformed chunk of the transformed chunks of each update layer based on the respective chunk offset identified for each chunk; chunking each weight of the plurality of update weights to generate a plurality of updated chunks; transforming each chunk of the plurality of updated chunks to generate a plurality of transformed chunks; and inserting the plurality of transformed chunks into the executable file based on the identified update offsets to generate an updated executable file.

In another example, an apparatus for modifying a binary file is provided that includes at least one memory and at least one processor (e.g., configured in circuitry) coupled to the at least one memory. The at least one processor configured to: obtain a plurality of update weights to apply to respective update layers of a plurality of update layers of an executable file representative of a machine-learning model; extract a plurality of weights from the executable file; divide the plurality of weights into a plurality of chunks; identify a respective chunk offset relative to a reference point in the executable file for each chunk of the plurality of chunks; transform update weights of each update layer of the plurality of update layers to generate respective transformed weights; chunk the respective transformed weights to generate transformed chunks for each update layer; identify an update offset relative to the reference point in the executable file for each transformed chunk of the transformed chunks of each update layer based on the respective chunk offset identified for each chunk; chunk each weight of the plurality of update weights to generate a plurality of updated chunks; transform each chunk of the plurality of updated chunks to generate a plurality of transformed chunks; and insert the plurality of transformed chunks into the executable file based on the identified update offsets to generate an updated executable file.

In another example, a non-transitory computer-readable medium is provided that has stored thereon instructions that, when executed by one or more processors, cause the one or more processors to: obtain a plurality of update weights to apply to respective update layers of a plurality of update layers of an executable file representative of a machine-learning model; extract a plurality of weights from the executable file; divide the plurality of weights into a plurality of chunks; identify a respective chunk offset relative to a reference point in the executable file for each chunk of the plurality of chunks; transform update weights of each update layer of the plurality of update layers to generate respective transformed weights; chunk the respective transformed weights to generate transformed chunks for each update layer; identify an update offset relative to the reference point in the executable file for each transformed chunk of the transformed chunks of each update layer based on the respective chunk offset identified for each chunk; chunk each weight of the plurality of update weights to generate a plurality of updated chunks; transform each chunk of the plurality of updated chunks to generate a plurality of transformed chunks; and insert the plurality of transformed chunks into the executable file based on the identified update offsets to generate an updated executable file.

In another example, an apparatus for modifying a binary file is provided. The apparatus includes: means for obtaining a plurality of update weights to apply to respective update layers of a plurality of update layers of an executable file representative of a machine-learning model; means for extracting a plurality of weights from the executable file; means for dividing the plurality of weights into a plurality of chunks; means for identifying a respective chunk offset relative to a reference point in the executable file for each chunk of the plurality of chunks; means for transforming update weights of each update layer of the plurality of update layers to generate respective transformed weights; means for chunking the respective transformed weights to generate transformed chunks for each update layer; means for identifying an update offset relative to the reference point in the executable file for each transformed chunk of the transformed chunks of each update layer based on the respective chunk offset identified for each chunk; means for chunking each weight of the plurality of update weights to generate a plurality of updated chunks; means for transforming each chunk of the plurality of updated chunks to generate a plurality of transformed chunks; and means for inserting the plurality of transformed chunks into the executable file based on the identified update offsets to generate an updated executable file.

Systems and techniques are described for storing an executable fil. According to at least one example, a method is provided for storing an executable fil. The method includes: transforming at least a portion of a binary file representative of a machine-learning model into a transformed binary file for execution; while transforming the machine-learning model, recording operations performed on weights of the machine-learning model as a graph and storing an ordering of inputs to the graph; converting the graph into a constant graph for execution; extracting data from the machine-learning model to generate a reduced model; and storing the reduced model, the constant graph, and the ordering as a context binary file.

In another example, an apparatus for storing an executable file is provided that includes at least one memory and at least one processor (e.g., configured in circuitry) coupled to the at least one memory. The at least one processor configured to: transform at least a portion of a binary file representative of a machine-learning model into a transformed binary file for execution; while transforming the machine-learning model, record operations performed on weights of the machine-learning model as a graph and storing an ordering of inputs to the graph; convert the graph into a constant graph for execution; extract data from the machine-learning model to generate a reduced model; and store the reduced model, the constant graph, and the ordering as a context binary file.

In another example, a non-transitory computer-readable medium is provided that has stored thereon instructions that, when executed by one or more processors, cause the one or more processors to: transform at least a portion of a binary file representative of a machine-learning model into a transformed binary file for execution; while transforming the machine-learning model, record operations performed on weights of the machine-learning model as a graph and storing an ordering of inputs to the graph; convert the graph into a constant graph for execution; extract data from the machine-learning model to generate a reduced model; and store the reduced model, the constant graph, and the ordering as a context binary file.

In another example, an apparatus for storing an executable file is provided. The apparatus includes: means for transforming at least a portion of a binary file representative of a machine-learning model into a transformed binary file for execution; means for while transforming the machine-learning model, recording operations performed on weights of the machine-learning model as a graph and storing an ordering of inputs to the graph; means for converting the graph into a constant graph for execution; means for extracting data from the machine-learning model to generate a reduced model; and means for storing the reduced model, the constant graph, and the ordering as a context binary file.

Systems and techniques are described for obtaining an executable file. According to at least one example, a method is provided for obtaining an executable file. The method includes: separating a context binary file to obtain a transformed binary file representative of a machine-learning model transformed for execution on a backend, a constant graph, and a mapping; arranging data from a machine-learning-model file according to the mapping; executing the constant graph using the arranged data to generate an output; and generating an updated binary file based on the transformed binary file and the output.

In another example, an apparatus for obtaining an executable file is provided that includes at least one memory and at least one processor (e.g., configured in circuitry) coupled to the at least one memory. The at least one processor configured to: separate a context binary file to obtain a transformed binary file representative of a machine-learning model transformed for execution on a backend, a constant graph, and a mapping; arrange data from a machine-learning-model file according to the mapping; execute the constant graph using the arranged data to generate an output; and generate an updated binary file based on the transformed binary file and the output.

In another example, a non-transitory computer-readable medium is provided that has stored thereon instructions that, when executed by one or more processors, cause the one or more processors to: separate a context binary file to obtain a transformed binary file representative of a machine-learning model transformed for execution on a backend, a constant graph, and a mapping; arrange data from a machine-learning-model file according to the mapping; execute the constant graph using the arranged data to generate an output; and generate an updated binary file based on the transformed binary file and the output.

In another example, an apparatus for obtaining an executable file is provided. The apparatus includes: means for separating a context binary file to obtain a transformed binary file representative of a machine-learning model transformed for execution on a backend, a constant graph, and a mapping; means for arranging data from a machine-learning-model file according to the mapping; means for executing the constant graph using the arranged data to generate an output; and means for generating an updated binary file based on the transformed binary file and the output.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for generating a binary file based on a machine-learning model;

FIG. 2 is a flow diagram illustrating a process of generating a binary file based on machine-learning model;

FIG. 3 is a block diagram illustrating an example system for generating a binary file based on a machine-learning model, according to various aspects of the present disclosure;

FIG. 4 is a flow diagram illustrating a process of generating a binary file based on machine-learning model, according to various aspects of the present disclosure;

FIG. 5 is a block diagram illustrating an example system for generating a context binary based on a machine-learning model, according to various aspects of the present disclosure;

FIG. 6 is a flow diagram illustrating a process of generating a binary context file based on machine-learning model, according to various aspects of the present disclosure;

FIG. 7 is a block diagram illustrating an example system for generating a rehydrated graph based on a context binary, according to various aspects of the present disclosure;

FIG. 8 is a flow diagram illustrating a process of generating a rehydrated graph based on a context binary file, according to various aspects of the present disclosure;

FIG. 9 is a flow diagram illustrating an example process for modifying a binary file, in accordance with aspects of the present disclosure;

FIG. 10 is a flow diagram illustrating an example process for storing a binary file, in accordance with aspects of the present disclosure;

FIG. 11 is a flow diagram illustrating an example process for obtaining a binary file, in accordance with aspects of the present disclosure;

FIG. 12 is a block diagram illustrating an example of a deep learning neural network that can be used to perform various tasks, according to some aspects of the disclosed technology;

FIG. 13 is a block diagram illustrating an example of a convolutional neural network (CNN), according to various aspects of the present disclosure; and

FIG. 14 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

To implement a machine-learning model (also referred to as a machine learning system) on a backend, some systems may transform the machine-learning model to improve performance of the transformed machine-learning model on the backend. For example, weights of a neural network may be constant data that is used by a neural signal processor (NSP) or neural processing unit (NPU) to execute a graph. For instance, weights may be used for convolution. Additionally or alternatively, weights may be used for matrix multiplication (MatMul) and/or normalizations (e.g., BatchNormalizations). The weights can be arranged in a matrix format, in some cases with padding and/or transposed in certain dimensions to enhance runtime performance. For instance, the weights can be transformed in value and/or position to achieve an optimal memory layout for each layer, depending on the dimensions, type of operation, and type of graph (e.g., 16-bit floating point (fp16) vs. quantized). Weights can even be padded with zeros to improve performance.

The transformations and optimizations that are applied to arrange weights of a machine-learning model into a layout acceptable to a backend and hardware (e.g., an NPU) may be unknown to model developers. This poses a challenge when model developers want to modify weights for a layer of the model.

In the present disclosure, the term “machine-learning model,” “model,” and like terms may refer to a model that has parameters (e.g., weights) that have been trained through a training process. A neural network is an example of such a machine-learning model. A graph neural network as another example of such a machine-learning model.

In the present disclosure, the term “binary file,” “executable file,” “binary image,” “image file,” “binary,” “context binary,” and like terms may refer to a file in a format that is executable by a processor.

In the present disclosure, the term “backend” may refer to it is a software stack that is compatible with a variety of architectures, for example, an x86 architecture, an advanced reduced instruction set computer (RISC) machine (ARM) architecture, etc.

In the present disclosure, the term “dehydrate” may refer to a process of generating a file based on a machine-learning model such that the generated file is smaller (in file size) than the machine-learning model. In the present disclosure, the term “rehydrate” may refer to the process of generating an executable file from a dehydrated file. The rehydrated file may allow a backend to execute the machine-learning model. The rehydrated file may be configured for (e.g., optimized for) the backend.

Systems, apparatuses, methods (also referred to as processes), and computer-readable media (collectively referred to herein as “systems and techniques”) are described herein for dynamically generating or modifying weights of a model based on a binary file representing the model. For example, the systems and techniques described herein may obtain a binary file representative of a machine-learning model and obtain updates to apply to the machine-learning model. The systems and techniques may apply the updates to the binary file directly.

A first example technique described herein is referred to as “external weight rehydration.” External weight rehydration may utilize an external rulebook to transform weights into the desired layout. One example use of external weight rehydration is in model preparation with dummy data. For example, a customer can initially prepare a model with dummy data and update the weights as needed. This approach allows for easy customization and fine-tuning based on specific use cases and data inputs. This approach may involve new rules, for example, this approach may include updating the rulebook externally to meet new requirements and transformations for each of the operations. In the present disclosure, the term “operations” may refer to ______.

A second example technique describe herein is referred to as “internal weight rehydration.” Internal weight rehydration may involve a “const” graph that executes with specific inputs, transforming them into the desired layout. Both external weight rehydration and internal weight rehydration may use a codebook that outlines where the weights need to be updated in the const weights buffers. One example use of internal weight rehydration is for reducing the size of a binary. By excluding the weight component, binaries can be optimized for ROM, allowing for different binaries tailored to each system on a chip (SoC), excluding weights.

An example use of either external weight rehydration or internal weight rehydration is dynamic weight updating. For example, weights can be adjusted dynamically based on new learning patterns, feature importance, and optimizations. This flexibility enables models to adapt in real-time to changing data and requirements.

Various aspects of the application will be described with respect to the figures below.

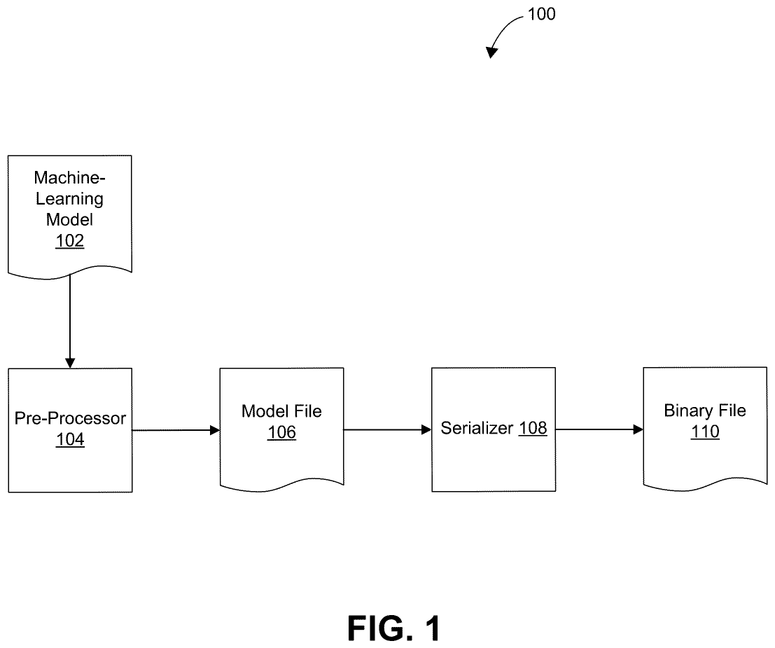

FIG. 1 is a block diagram illustrating an example system 100 for generating a binary file 110 based on a machine-learning model 102. As mentioned previously, to implement a machine-learning model (e.g., machine-learning model 102) on a backend, some systems (e.g., system 100) may transform the machine-learning model into a binary file (e.g., binary file 110) configured to run on the backend. For example, weights of a neural network (e.g., weights of machine-learning model 102) may be constant data used by a neural signal processor (NSP) or neural processing unit (NPU) to execute a graph. The weights can be arranged in a matrix format with padding and/or transposed in certain dimensions to enhance runtime performance. For instance, the weights can be transformed in value and/or position to achieve an optimal memory layout for each layer, depending on the dimensions, type of operation, and type of graph (e.g., 16-bit floating point (fp16) vs. quantized). Weights can even be padded with zeros to improve performance. For example, pre-processor 104 may arrange values of machine-learning model 102 in a matrix format, pad, the values, and/or transpose the values, to generate model file 106. Serializer 108 may serialize the values of model file 106 to generate binary file 110. The backend may execute binary file 110. Pre-processor 104 and/or serializer 108 may format, arrange, transpose, pad, the values of machine-learning model 102 such that binary file 110 is configured for execution on the NPU.

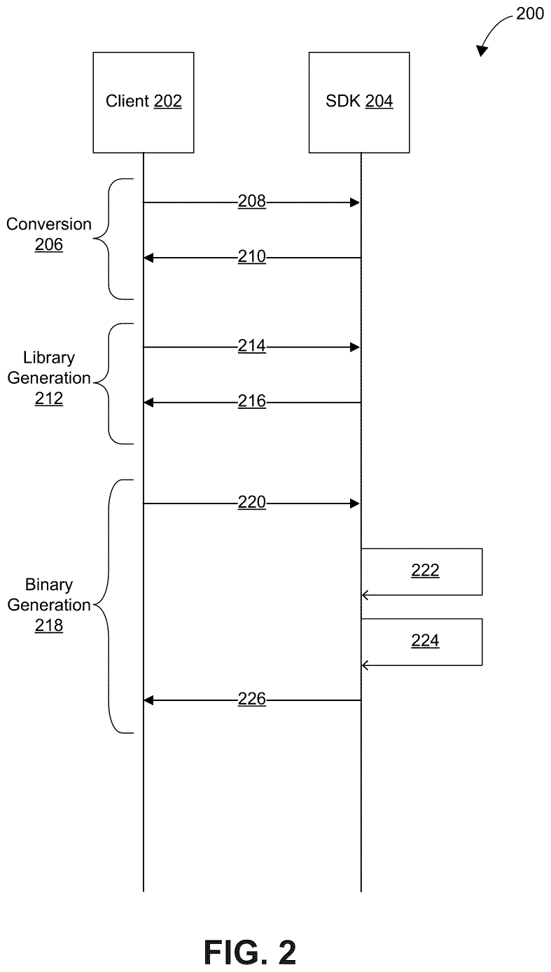

FIG. 2 is a flow diagram illustrating a process 200 of generating a binary file based on machine-learning model. For example, system 100 may implement process 200 to generate binary file 110 based on machine-learning model 102.

Client 202 may be an example of an application that may seek to implement a machine-learning model or use a machine-learning model at inference to generate output data based on input data. Client 202 may be implemented at a user device. For example, client 202 may be an application running in a smartphone of a user.

Software developer kit (SDK) 204 is an example of a set of tools and/or libraries that may generate a binary file based on a machine-learning model at the request of client 202. SDK 204 may be implemented in a user device or in a cloud computer device (e.g., a remote server). For example, client 202 may send requests to SDK 204 and SDK 204 may perform the requested operations and send the results to client 202.

At conversion 206, client 202 may sent a request for a model to SDK 204. For example, operation 208 may include a call to a converter. At operation 210, SDK 204 may provide a model to client 202. The model may include weights (e.g., weights of layers of a machine-learning model).

At library generation 212, client 202 may sent a request for a library to SDK 204. For example, operation 214 may include a call to a library generator. At operation 216 SDK 204 may provide a library (e.g., a number of executable programs or packages that client 202 may use to implement the machine-learning model).

At binary generation 218, client 202 may send a request for a binary file to SDK 204. For example, operation 220 may include a call to a binary generator. At operation 222, SDK 204 may prepare a model. At operation 224, SDK 204 may serialize the model. At operation 226, SDK 204 may provide a binary file representative of the model to client 202. The provided model may be static.

Returning to FIG. 1, the transformations and optimizations (e.g., formatting, arranging, transposing, padding, etc.) applied by pre-processor 104 and/or serializer 108 to arrange weights of a machine-learning model 102 into binary file 110 may be unknown the developer of machine-learning model 102. This poses a challenge when the model developers want to modify weights for a layer of machine-learning model 102. For example, the model developers may not be able to modify weights of binary file 110 directly. For example, binary file 110 may be static, for example, the contents of binary file 110 may not be changeable.

External weight rehydration may modify content at the binary level before feeding it back to an application programming interface (API) for deserialization and execution.

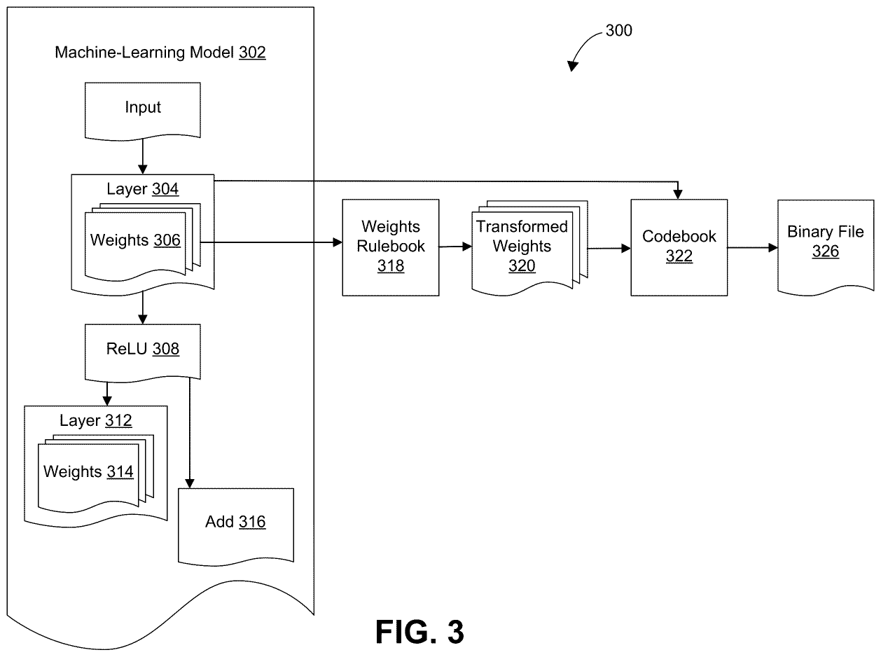

FIG. 3 is a block diagram illustrating an example system 300 for patching a binary file 326 based on a machine-learning model 302, according to various aspects of the present disclosure. System 300 may implement external weight rehydration. For example, system 300 may transform framework layer weights for compatibility with a backend.

Machine-learning model 302 is an example machine-learning model including layers (e.g., layer 304 and layer 312). Each layer includes weights, as examples layer 304 includes weights 306 and layer 312 includes weights 314. Machine-learning model 302 may include any number of layers with any number of weights. Additionally, machine-learning model 302 may include other operators, for example, machine-learning model 302 includes a rectified linear unit (ReLU) 308. Outputs from ReLU 308 and layer 312 may be stored, as an example, address (“add”) 316.

External weight rehydration may include transforming weights of machine-learning model 302 using weights rulebook 318 to generate transformed weights 320. For example, weights rulebook 318 may transform static weights into a layout and value format that may be efficient (e.g., optimal) for the backend.

Some of the operations performed by weights rulebook 318 may include padding, tiling, data packing, data reordering, and partitioning.

Padding may cause data chunks to have a similar length (e.g., the same length). Padding may facilitate data alignment and batch processing in neural networks.

Tiling may reduce a memory footprint by breaking down large matrices into smaller chunks. Smaller chunks may fit into cache better which may reduce the need for frequent memory access. Additionally, smaller tiles can be distributed across multiple processing units, leading to faster computations.

Data packing and/or reordering may reorganize data into a compact format to improve memory efficiency and speed. Values may be selected from various dimensions and arranged to optimize processing for the NPU.

Partitioning may split data into separate regions or partitions. Partitioning the data into separate regions may be useful for parallel processing and/or when different parts of the data need to be accessed or processed differently.

In some aspects, weights rulebook 318 may segment the weights into smaller chunks. The chunks may be suitable for processing using the NPU. For example, weights rulebook 318 may segment weights (e.g., weights 306 and/or weights 314) into chunks of 128 to 2048 bytes. Each chunk may be an integer multiple of 128 bytes. The chunks are stored in the serialized binary (e.g., in binary file 326).

Codebook 322 may map each layer (e.g., layer 304 and layer 312) to its respective offset(s) in the serialized binary (e.g., in binary file 326). This mapping is used to update the weights externally. Binary file 326 may be an updated serialized binary that incorporates the new weights data.

System 300 may obtain a binary file that represents a machine-learning model. Additionally, system 300 may obtain machine-learning model 302 that may include intended updates for the machine-learning model. For example, at least some of the weights of machine-learning model 302 may be different from the corresponding weights of the machine-learning model represented by the binary file.

System 300 may transform at least the updated weights of machine-learning model 302 to generate transformed weights 320. Codebook 322 may determine an offset into the binary file at which to insert each of the updated weights. Further, codebook 322 may insert the updated weights into the binary file to generate binary file 326.

In general, system 300 may extract weights from the serialized binary. For example, system 300 may extract weights from a binary file that represents a machine-learning model.

Further, system 300 may create a codebook (e.g., codebook 322). To create codebook 322, system 300 may chunk the weights files (e.g., the weights of machine-learning model 302) into multiples of 128 bytes, up to 2048 bytes. From the model's original weights, system 300 may process each layer with weights and transform them into a backend-specific format. For example, weights rulebook 318 may generate transformed weights 320 based on weights 306 and/or weights 314 of machine-learning model layer 304 and layer 312 respectively. Further, system 300 may map the transformed weights to the weights in the extracted file to create a mapping of offset. For example, system 300 may determine an offset into the binary file for updated weights of transformed weights 320. For example, system 300 may create a map including key and value pairs, such as “Map: {Key: layer name, Value: [offsets to update in the binary]).”

Given a layer and its new weights, system 300 may transform the news (or updated) weights into the backend-specific format using the same chunk size as earlier. For example, weights rulebook 318 may transform the updated weights to generate transformed weights 320.

Further, for each layer, system 300 may use the codebook to update each chunk at the specified offsets. For example, codebook 322 may update chunks at the determined offsets to reflect transformed weights 320.

Further, system 300 may attach the updated weights to the serialized binary. For example, codebook 322 may insert the updated chunks into the binary file.

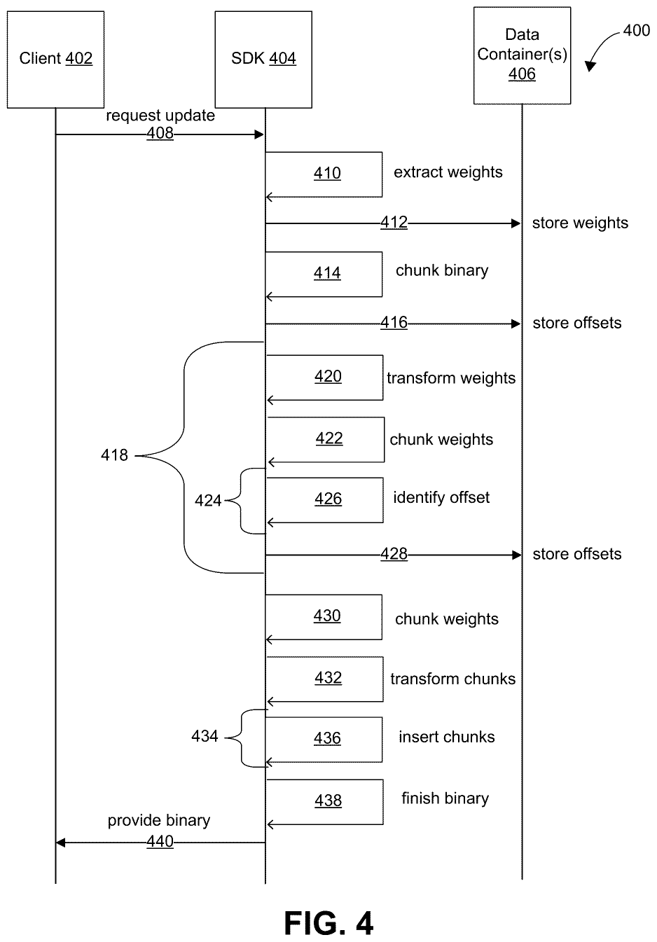

FIG. 4 is a flow diagram illustrating a process 400 of generating a binary file based on machine-learning model, according to various aspects of the present disclosure. For example, system 300 may implement process 400 to generate binary file 326 based on machine-learning model 302.

Client 402 may be an example of an application that may seek to implement a machine-learning model or use a machine-learning model at inference to generate output data based on input data. Client 402 may be implemented at a user device. For example, client 402 may be an application running in a smartphone of a user.

Software developer kit (SDK) 404 is an example of a set of tools and/or libraries that may generate a binary file based on a machine-learning model at the request of client 402. SDK 404 may be implemented in a user device or in a cloud computer device (e.g., a remote server). For example, client 402 may send requests to SDK 404 and SDK 404 may perform the requested operations and send the results to client 402.

Data container(s) 406 may store artifacts from SDK 404. For example, SDK 404 may use data container(s) 406 to store data as SDK 404 performs operations (e.g., to generate a binary file based on a machine-learning model.

At operation 408, client 402 may request that SDK 404 update a binary representative of a machine-learning model. Client 402 may provide to SDK 404 the binary file to be updated, the machine-learning model represented by the binary file, the layers to be updated with new weights, and the new weights.

At operation 410, SDK 404 may extract a plurality of weights from the executable file. The weights extracted at operation 410 may be from the binary that were prepared with the original weights. The weights may be in “transformed” form At operation 412, SDK 404 may store transformed weights using data container(s) 406.

At operation 414, the weights file is divided into chunks. For example, the plurality of weights obtained at operation 408 is divided into a plurality of chunks. Each chunk may be the same size. Further each chunk may be a multiple of 128 bytes (e.g., up to a size of 2048 bytes).

Further, at operation 414, a respective chunk offset may be identified for each chunk. The chunk offsets may be relative to a reference point in the executable file. As an example, the reference point may be the start of the binary file. As another example the reference point may be relative to a weights portion of the binary file. At operation 416, SDK 404 may store the chunk offsets using data container(s) 406.

Operation 420, operation 422, operation 426, and operation 428 may be performed once for each layer of the layers indicated at operation 408. For example, operation 418 indicates the iterative repetition of operation 420, operation 422, operation 426, and operation 428 for each of the layers.

At operation 420, weights of a given layer may be padded, tiled, packed, reordered, and/or partitioned (e.g., as described with regard to the operation of weights rulebook 318). For example, at operation 420, update weights of each update layer of the plurality of update layers may be transformed to generate respective transformed weights.

At operation 422, the transformed weights may be chunked to generate transformed chunks for each update layer. The chunking of operation 422 may use the same chunk size as operation 414. Operation 426 may be performed once for each chunk of the chunks generated at operation 422. For example, operation 424 indicates the iterative repetition of operation 426 for each of the chunks.

At operation 426, an update offset relative to the reference point in the executable file may be identified for each transformed chunk of the transformed chunks of each update layer based on the respective chunk offset identified for each chunk. For example, for each of the chunks generated at operation 422, an offset relative to the binary file may be identified. The offset may be identified based on the offsets determined at operation 414. For example, each chunk of each weight of the original machine-learning model may map to an offset in the original binary file. At operation 414, the mapping between chunks in the original machine-learning model and the original binary file may be determined. At operation 426, an offset for each updated chunk may be determined based on the mapping of the original chunks to offsets. At operation 428, SDK 404 may store updated chunk offsets using data container(s) 406.

At operation 430, each new weight may be chunked. For example, the new weights provided at operation 408 may be chunked. The chunking size may be the same chunk size used at operation 414 and/or operation 422. For example, at operation 430, each weight of the plurality of update weights may be chunked to generate a plurality of updated chunks.

At operation 432, each of the chunks generated at operation 430 may be transformed. The transformations of chunks at operation 432 may be as described with regard to weights rulebook 318. For example, each chunk of the plurality of updated chunks may be transformed to generate a plurality of transformed chunks.

Operation 436 may be performed once for each offset of the offsets (for chunks) identified at operation 426. For example, operation 434 indicates the iterative repetition of operation 436 for each of the offsets.

At operation 436, each updated chunk may be inserted into the binary file at the offset corresponding to the updated chunk. For example, the plurality of transformed chunks may be inserted into the executable file based on the identified update offsets to generate an updated executable file.

At operation 438, the inserted weights may be baked into the binary file. For example, the newly transformed weights are integrated into the original binary at specific offsets within the weights region for each layer. At operation 440, the updated binary file may be provided to client 402.

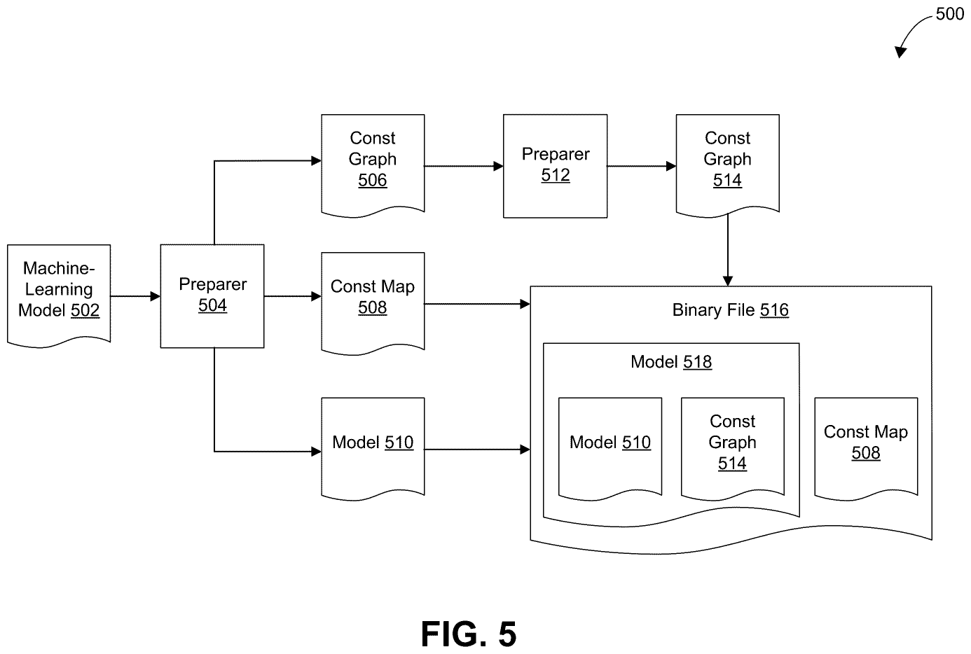

FIG. 5 is a block diagram illustrating an example system 500 for generating a binary file 516 based on a machine-learning model 502, according to various aspects of the present disclosure. System 500 may implement internal weight dehydration. For example, system 500 may dehydrate a model that may be later rehydrated (e.g., by the same device that dehydrated the model, or by another device). For example, system 500 may involve removal of constant (“const”) data from a graph saved in memory (e.g., read-only memory (ROM)). In the present disclosure, the term “const” may refer to data that does not change from execution to execution. Weights are an example of constant data. The const data is determined through training and fixed once the graph is finalized.

Preparer 504 may prepare model 510 based on machine-learning model 502. Machine-learning model 502 may be a binary file representative of a machine-learning model. Additionally, while preparing model 510, preparer 504 may generate an API recording of all operations (e.g., const optimizations) performed while preparing model 510. preparer 504 may store the operations as const graph 506. In addition, preparer 504 may generate const map 508. Const map 508 may describe the order of raw const data from the model as input to the const graph (e.g., const graph 506).

While the source graph (e.g., const graph 506) is prepared, each operation (e.g., optimization and transform) applied to const data while being formatted for backend execution is recorded through specialized transformation operations in a separate graph called the const graph (e.g., const graph 506). The original graph is stored to disk without this const data (e.g., the optimized const data). The const graph (e.g., const graph 506) is itself operated upon (e.g., optimized) and prepared into a format to be executed by the backend (e.g., as const graph 514).

For example, preparer 504 may transform at least a portion of a binary file representative of a machine-learning model (e.g., machine-learning model 502) into a transformed binary file for execution. For instance, preparer 504 may transform the constant data section of the binary file representative of machine-learning model 502 for execution on a backend (e.g., generating model 510). While transforming the machine-learning model, preparer 504 may record operations performed on weights of the machine-learning model as const graph 506 and store an ordering of inputs to the graph (e.g., const map 508). The inputs to the graph may be the constant nodes of the original graph. The order in which the constant nodes should be supplied to the const graph is the order in which the inputs are added to the original graph.

After generation of the const graph 506, preparer 512 may generate const graph 514 based on const graph 506. Const graph 514 may be, or may include, const graph 506 in a format for later use (e.g., by a backend).

System 500 may store const graph 514 in a model 518 of binary file 516. Additionally, system 500 may include const map 508 in binary file 516. For example, system 500 may write const map 508 to a flat buffer in binary file 516.

After preparing const graph 514, a replaceable memory (e.g., “MemPool”) within a const segment (e.g., binary file 516) will contain a flag indicating that model 510 is a dehydrated MemPool. The contents of this MemPool will be excluded from model 510. System 500 may store model 510 in binary file 516.

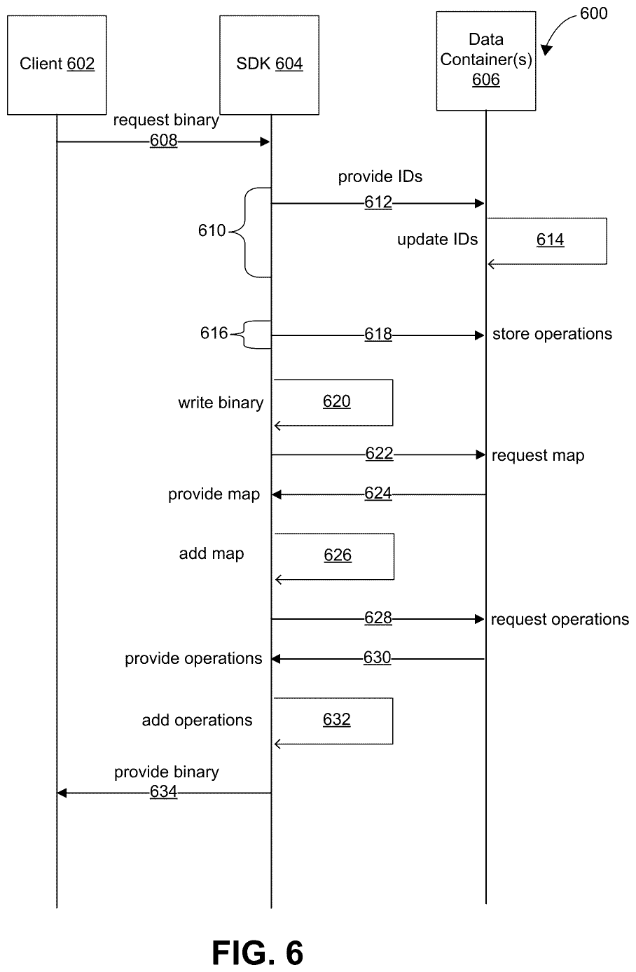

FIG. 6 is a flow diagram illustrating a process 600 of generating a binary context file based on machine-learning model, according to various aspects of the present disclosure. For example, system 500 may implement process 600 to generate binary file 516 based on machine-learning model 502.

Client 602 may be an example of an application that may seek to implement a machine-learning model or use a machine-learning model at inference to generate output data based on input data. Client 602 may be implemented at a user device. For example, client 602 may be an application running in a smartphone of a user.

Software developer kit (SDK) 604 is an example of a set of tools and/or libraries that may generate a binary file based on a machine-learning model at the request of client 602. SDK 604 may be implemented in a user device or in a cloud computer device (e.g., a remote server). For example, client 602 may send requests to SDK 604 and SDK 604 may perform the requested operations and send the results to client 602.

Data container(s) 606 may store artifacts from SDK 604. For example, SDK 604 may use data container(s) 606 to store data as SDK 604 performs operations (e.g., to generate a binary file based on a machine-learning model.

At operation 608, client 602 may request that SDK 604 dehydrate a binary representative of a machine-learning model. Client 602 may provide to SDK 404 the binary file to be updated.

Operation 612 and operation 614 may be performed once for each const in the original const graph of the machine-learning model. For const 610 indicates the iterative repetition of operation 612 and operation 614 for each of the consts. At operation 612 and operation 614, all const nodes in the model may be tracked for graph preparation.

For example, at operation 612, SDK 604 may provide identifiers (IDs) of consts of the original graph to data container(s) 606 for storage. At operation 614, data container(s) 606 may update a map of IDs.

Operation 618 may be performed once for each operation (e.g., optimization) performed on consts in the original const graph of the machine-learning model. For operations 616 indicates the iterative repetition of for operations 616 for each of the operations.

At operation 618 SDK 604 may store each operation at data container(s) 606. For example, as process 600 operates on the binary including the machine-learning model, process 600 may store the operations (e.g., as const graph 506). For example, all operations (e.g., optimizations) are recorded into an API record.

At operation 620, SDK 604 may write the binary without const data. For example, the prepared graph binary is stored in RAM without const data.

At operation 622, after completing the operations on the binary, SDK 604 may request a map (e.g., const map 508) from data container(s) 606. At operation 624, data container(s) 606 may provide the map to SDK 604. At operation 626, SDK 604 may add the map to the binary. For example, system 500 may add const map 508 to binary file 516.

At operation 628, after completing the operations on the binary, SDK 604 may request a record of the operations performed (e.g., const graph 506) from data container(s) 606. At operation 630, data container(s) 606 may provide the operations to SDK 604. At operation 632, SDK 604 may add the operations to the binary. For example, system 500 may add const graph 506 to binary file 516. At operation 634, the dehydrated binary file may be provided to client 602.

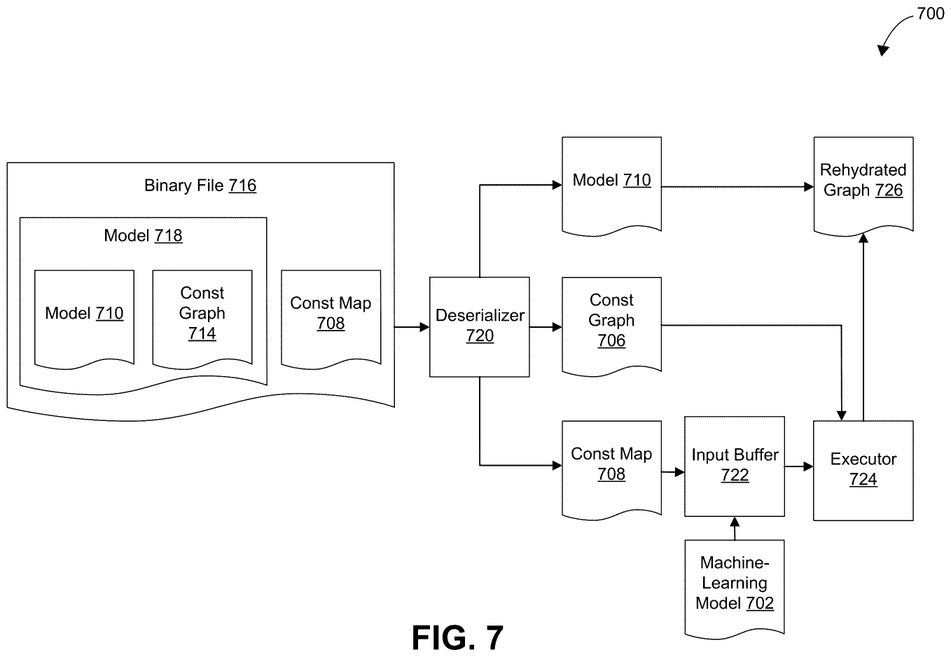

FIG. 7 is a block diagram illustrating an example system 700 for generating a rehydrated graph 726 based on a binary file 716, according to various aspects of the present disclosure. System 700 may implement internal weight rehydration. For example, system 700 may rehydrate a model that was previously dehydrated (e.g., by system 500 according to process 600). For example, system 700 may reconstruct the prepared const data for a graph prior to execution. In some aspects, System 700 may be implemented in the same system or device as system 500. For example, such an example system or device may dehydrate a model, and later rehydrate the model. Additionally or alternatively, System 700 and system 500 may be implemented by separate systems or devices. For example, system 500 may dehydrate a model and provide the dehydrated model to System 700. System 700 may rehydrate the model (e.g., at a later time and/or at a location separate from the location of system 500).

Binary file 716 may be an example of binary file 516. For example, const map 708 may be an example of const map 508, model 710 may be an example of model 510, const graph 714 may be an example of const graph 514, and model 718 may be an example of model 518. Additionally, machine-learning model 702 may be an example of machine-learning model 502.

Deserializer 720 may extract const graph 706, const map 708, and model 710 from binary file 716. For example, deserializer 720 may deserialize model 710 and const graph 706 from within the binary file 716. Additionally, deserializer 720 may extract const map 708 from binary file 716.

System 700 may arrange raw tensor data from the original model file (e.g., machine-learning model 702) into input buffer 722 in the order described by the const map 708. Before the prepared source graph is executed, the const graph is executed using the original tensor data from the source graph file, or an alternate source graph file. The output from the const graph execution is a buffer of formatted tensor data ready for backend execution.

Executor 724 may execute const graph 706 using input buffer 722 (which may be constructed from machine-learning model 702). The prepared source graph is executed using the formatted tensor data from the Const Graph execution.

System 700 may use the output from the const graph execution (e.g., the output of executor 724 executing const graph 706 using inputs from machine-learning model 702 ordered according to const map 708) to repopulate the dehydrated MemPool from model 710. For example, system 700 may generate rehydrated graph 726 based on model 710 and the execution of const graph 706.

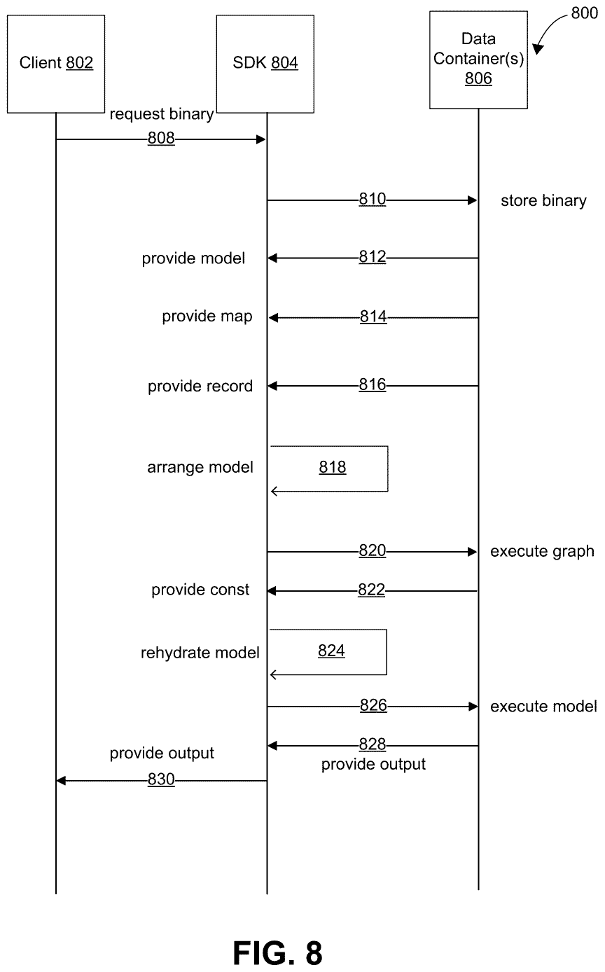

FIG. 8 is a flow diagram illustrating a process 800 of generating a rehydrated graph based on a context binary file, according to various aspects of the present disclosure. For example, system 700 may implement process 800 to generate rehydrated graph 726 based on binary file 716.

Client 802 may be an example of an application that may seek to implement a machine-learning model or use a machine-learning model at inference to generate output data based on input data. Client 802 may be implemented at a user device. For example, client 802 may be an application running in a smartphone of a user.

Software developer kit (SDK) 804 is an example of a set of tools and/or libraries that may generate a binary file based on a machine-learning model at the request of client 802. SDK 804 may be implemented in a user device or in a cloud computer device (e.g., a remote server). For example, client 802 may send requests to SDK 804 and SDK 804 may perform the requested operations and send the results to client 802.

Data container(s) 806 may store artifacts from SDK 804. For example, SDK 804 may use data container(s) 806 to store data as SDK 804 performs operations (e.g., to generate a binary file based on a machine-learning model.

At operation 808, client 802 may request that SDK 804 rehydrate a binary representative of a machine-learning model. Client 802 may provide to SDK 404 the original model file (e.g., machine-learning model 702), along with the dehydrated binary file to SDK 804 (e.g., binary file 716). Additionally, at operation 808, client 802 may provide input data to SDK 804. At operation 808, client 802 may instruct SDK 804 to execute the rehydrated model to process the input data.

At operation 810, SDK 804 may deserialize the dehydrated binary file. For example, at operation 810, SDK 804 may provide the dehydrated binary file to data container(s) 806. Data container(s) 806 may store the deserialize binary file. Additionally, data container(s) 806 may provide to SDK 804, the deserialized model (e.g., model 710), at operation 812, the mapping file (e.g., const map 708) at operation 814, and the API record of operations performed to dehydrate machine-learning model 702 (e.g., const graph 706), at operation 816.

At operation 818, data from the original model file is arranged into an input buffer. For example, data from machine-learning model 702 is arranged according to const map 708 in input buffer 722.

At operation 820, the const graph is executed using data from the input buffer. At operation 822, data container(s) 806 returns formatted const data to SDK 804.

At operation 824, the output from the const graph is used to rehydrate the const MemPool of the dehydrated model. For example, the output of executing const graph 706 using data from input buffer 722 is used to rehydrate model 710.

At operation 826, the rehydrated model is executed normally. For example, the rehydrated model is used, to generate output data based on input data.

At operation 828, data container(s) 806 provides output data to SDK 804. At operation 830, the output data is provided to client 802.

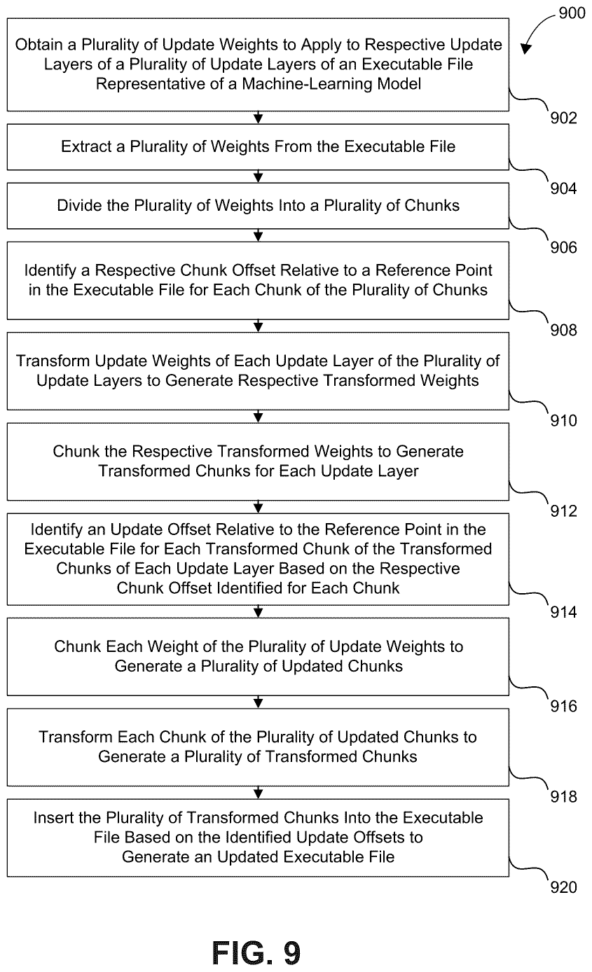

FIG. 9 is a flow diagram illustrating an example process 900 for modifying a binary file, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 900. The one or more operations of process 900 may be implemented as software components that are executed and run on one or more processors.

At block 902, a computing device (or one or more components thereof) may obtain a plurality of update weights to apply to respective update layers of a plurality of update layers of an executable file representative of a machine-learning model. For example, client 402 may provide update weights (e.g., weights 306 and/or weights 314) of update layers (e.g., layer 304 and/or layer 312( ) of an executable file representative of a machine-learning model (e.g., machine-learning model 302) to SDK 404 (e.g., at operation 408).

In some aspects, the machine-learning model may be, or may include, a graph neural network. In some aspects, the executable file may be, or may include, an executable binary file.

At block 904, the computing device (or one or more components thereof) may extract a plurality of weights from the executable file. For example, SDK 404 may extract weights (e.g., weights 306 and/or weights 314) from the executable file (e.g., at operation 410).

At block 906, the computing device (or one or more components thereof) may divide the plurality of weights into a plurality of chunks. For example, SDK 404 may divide (e.g., chunk) the executable file into chunks (e.g., at operation 414).

At block 908, the computing device (or one or more components thereof) may identify a respective chunk offset relative to a reference point in the executable file for each chunk of the plurality of chunks. For example, SDK 404 may identify chunk offsets for the chunks generated at block 906 (e.g., at operation 416). The chunk offsets may be relative to a reference point in the executable file.

At block 910, the computing device (or one or more components thereof) may transform update weights of each update layer of the plurality of update layers to generate respective transformed weights. For example, SDK 404 may transform weights (e.g., weights 306 and/or weights 314) to generate transformed weights 320 (e.g., at operation 420).

In some aspects, to transform a chunk, the computing device (or one or more components thereof) may pad a value of the chunk; tile a matrix of values of the chunk; reorder values of the chunk; or partition values of the chunk.

At block 912, the computing device (or one or more components thereof) may chunk the respective transformed weights to generate transformed chunks for each update layer. For example, SDK 404 may chunk the transformed weights (e.g., at operation 422).

At block 914, the computing device (or one or more components thereof) may identify an update offset relative to the reference point in the executable file for each transformed chunk of the transformed chunks of each update layer based on the respective chunk offset identified for each chunk. For example, SDK 404 may identify update offsets for the transformed chunks based on the chunk offsets identified at block 908 (e.g., at operation 426).

At block 916, the computing device (or one or more components thereof) may chunk each weight of the plurality of update weights to generate a plurality of updated chunks. For example, SDK 404 may chunk weights extracted at block 904 (e.g., at operation 430).

At block 918, the computing device (or one or more components thereof) may transform each chunk of the plurality of updated chunks to generate a plurality of transformed chunks. For example, SDK 404 may transform the chunks transformed at block 916 (e.g., at operation 432).

At block 920, the computing device (or one or more components thereof) may insert the plurality of transformed chunks into the executable file based on the identified update offsets to generate an updated executable file. For example, SDK 404 may insert the chunks into the binary filed (e.g., at operation 436).

In some aspects, the computing device (or one or more components thereof) may execute the updated executable file. Additionally or alternatively, the computing device (or one or more components thereof) may provide the executable file to another computing device (or one or more components thereof) that may execute the binary file.

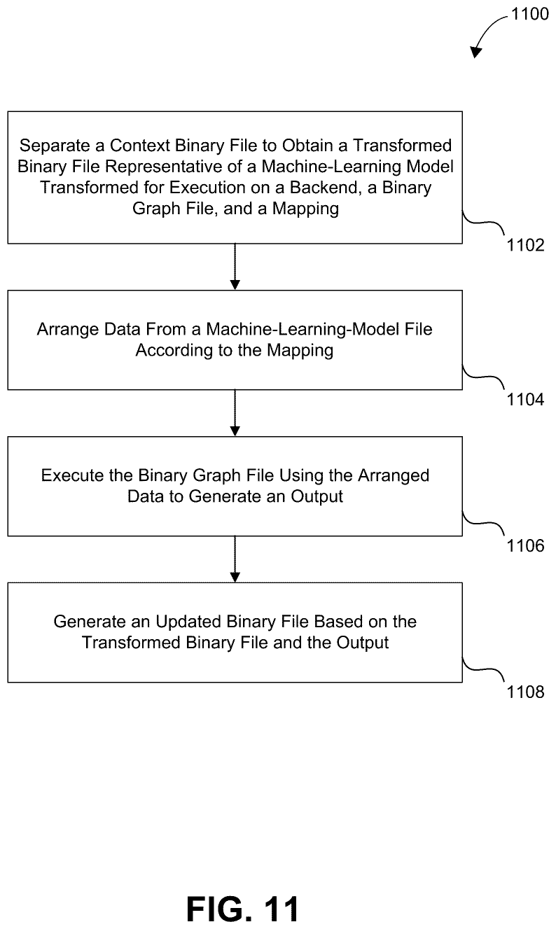

FIG. 11 is a flow diagram illustrating an example process 1100 for storing an executable file, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100. The one or more operations of process 1100 may be implemented as software components that are executed and run on one or more processors.

At block 1002, a computing device (or one or more components thereof) may transform at least a portion of a binary file representative of a machine-learning model into a transformed binary file for execution. For example, system 500 may transform a binary file such that the transformed binary file is configured for execution.

In some aspects, to transform a chunk, the computing device (or one or more components thereof) may pad a value of the chunk; tile a matrix of values of the chunk; reorder values of the chunk; or partition values of the chunk.

In some aspects, the machine-learning model may be, or may include, a graph neural network. In some aspects, the executable file may be, or may include, an executable binary file.

At block 1004, the computing device (or one or more components thereof) may while transforming the machine-learning model, record operations performed on weights of the machine-learning model as a graph and storing an ordering of inputs to a constant graph. For example, preparer 504 may store operations used to transform the binary file at block 1002. The operations may be stored as a graph (e.g., const graph 506). Additionally, preparer 504 may store const map 508 (e.g., an ordering of inputs for const graph 514).

In some aspects, the inputs to the graph may be, or may include, nodes of the machine-learning model including constant data of the machine-learning model; and the ordering of inputs to the constant graph may be, or may include, an order in which the nodes of the machine-learning model are added to the machine-learning model. For example, inputs to const graph 514 may be, or may include, nodes of the machine-learning model 502. Additionally, const map 508 may be, or may include, an order in which the nodes machine-learning model 502 are added to machine-learning model 502.

At block 1006, the computing device (or one or more components thereof) may convert the graph into a constant graph for execution. For example, preparer 512 may convert const graph 506 into constant graph 514.

At block 1008, the computing device (or one or more components thereof) may extract data from the machine-learning model to generate a reduced model. For example, system 500 may generate model 510.

At block 1010, the computing device (or one or more components thereof) may store the reduced model, the constant graph, and the ordering as a context binary file. For example, system 500 may store model 510 in binary file 516.

In some aspects, the computing device (or one or more components thereof) may to provide the context binary file to a device that is configured to extract the transformed binary file. System 500 may provide binary file 516 to another computing device (or one or more components thereof). The other computing device (or one or more components thereof) may extract the transformed binary file from binary file 516.

In some aspects, the device is further configured to update the transformed binary file. For example, the other computing device (or one or more components thereof) may update the transformed binary file.

In some aspects, the device is further configured to execute the transformed binary file. For example, the other computing device (or one or more components thereof) may execute the transformed binary file.

In some aspects, the device is further configured to provide the transformed binary file to another device for execution. For example, the other computing device (or one or more components thereof) may provide the transformed binary file to yet another computing device (or one or more components thereof) for execution.

FIG. 11 is a flow diagram illustrating an example process 1100 for obtaining an executable file, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100. The one or more operations of process 1100 may be implemented as software components that are executed and run on one or more processors.

At block 1102, a computing device (or one or more components thereof) may separate a context binary file to obtain a transformed binary file representative of a machine-learning model transformed for execution on a backend, a constant graph, and a mapping. For example, deserializer 720 may separate binary file 716 into model 710, const graph 706, and const map 708.

In some aspects, the transformed binary file has been generated using at least one of padding a value of a chunk of a weight of the machine-learning model represented by the transformed binary file; tiling a matrix of values of the chunk; reordering values of the chunk; or partitioning values of the chunk.

In some aspects, the machine-learning model may be, or may include, a graph neural network. In some aspects, the executable file may be, or may include, an executable binary file.

At block 1104, a computing device (or one or more components thereof) may arrange data from a machine-learning-model file according to the mapping. For example, system 700 may arrange data of machine-learning model 702 according to const map 708.

At block 1106, a computing device (or one or more components thereof) may execute the constant graph using the arranged data to generate an output. For example, executor 724 may execute const graph 706 using data arranged from machine-learning model 702 based on const map 708.

At block 1108, a computing device (or one or more components thereof) may generate an updated binary file based on the transformed binary file and the output. For example, system 700 may generate rehydrated graph 726 based on model 710 and outputs of executor 724 executing const graph 706 based on data of machine-learning model 702 ordered based on const map 708.

In some aspects, the computing device (or one or more components thereof) may execute the transformed binary file. For example, system 700 may execute rehydrated graph 726. Additionally or alternatively, the computing device (or one or more components thereof) may store the transformed binary file (e.g., for execution at a later time and/or for providing the transformed binary file to another device at a later time).

In some aspects, computing device (or one or more components thereof) may provide the transformed binary file to another device for execution. For example, system 700 may provide the transformed binary file to another computing device (or one or more components thereof) for execution.

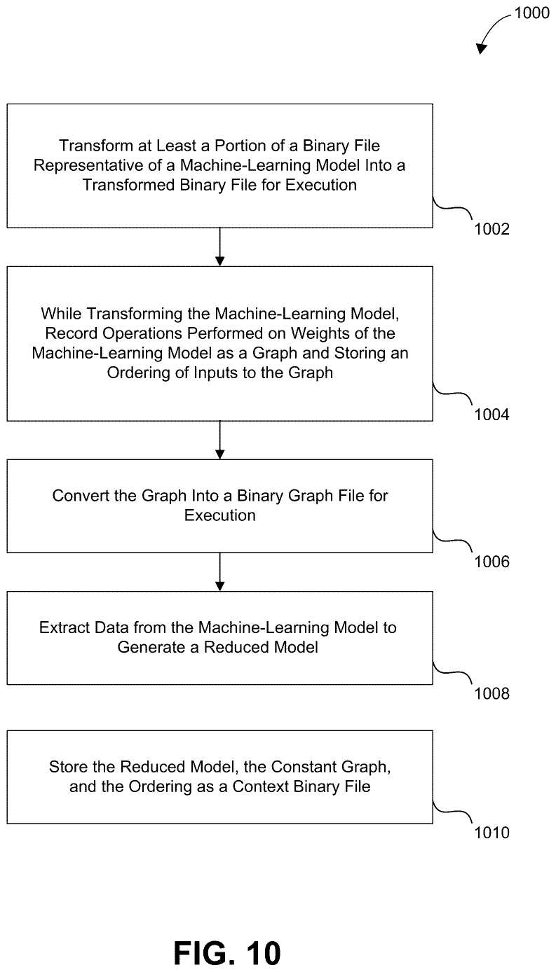

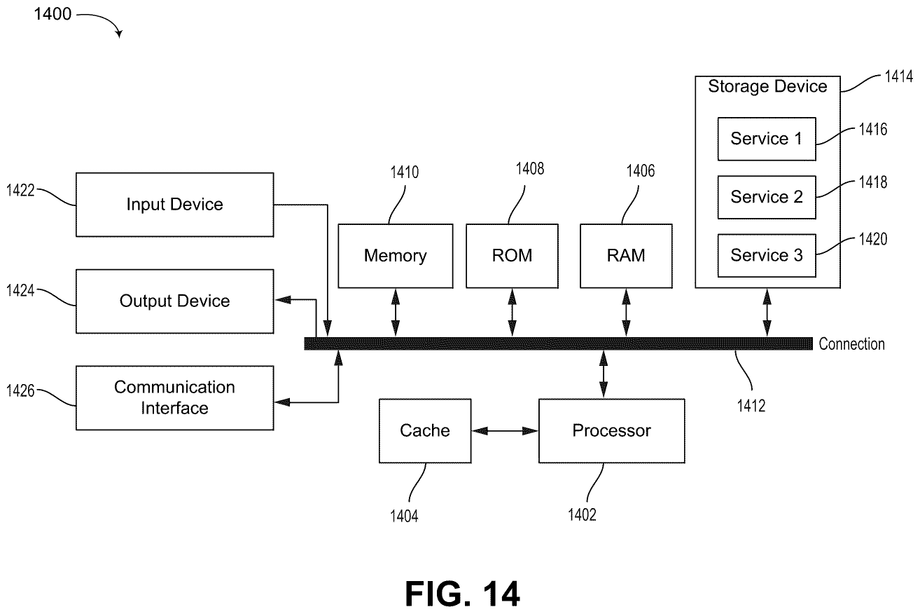

In some examples, as noted previously, the methods described herein (e.g., process 400 of FIG. 4, process 600 of FIG. 6, process 800 of FIG. 8, process 900 of FIG. 9, process 1000 of FIG. 10, process 1100 of FIG. 11, and/or other methods described herein) can be performed, in whole or in part, by a computing device or apparatus. In one example, one or more of the methods can be performed by system 300 of FIG. 3, system 500 of FIG. 5 system 700 of FIG. 7, or by another system or device. In another example, one or more of the methods (e.g., process 400, process 600, process 800, process 900, process 1000, process 1100, and/or other methods described herein) can be performed, in whole or in part, by the computing-device architecture 1400 shown in FIG. 14. For instance, a computing device with the computing-device architecture 1400 shown in FIG. 14 can include, or be included in, the components of the system 300, system 500, system 700, and can implement the operations of process 400, process 600, process 800, process 900, process 1000, process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 400, process 600, process 800, process 900, process 1000, process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 400, process 600, process 800, process 900, process 1000, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

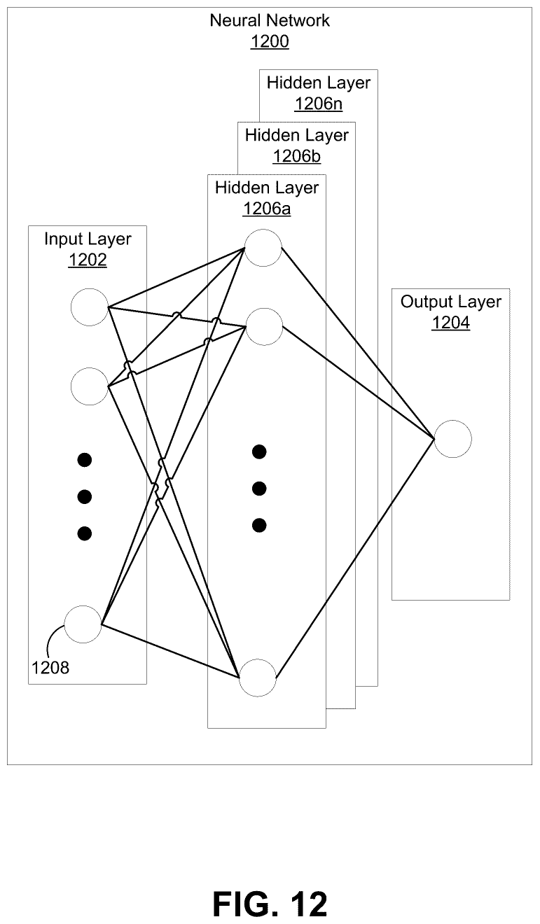

FIG. 12 is an illustrative example of a neural network 1200 (e.g., a deep-learning neural network) that can be used to implement machine-learning based feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1200 may be an example of, or can implement, machine-learning model 102 of FIG. 1, machine-learning model 302 of FIG. 3, machine-learning model 502 of FIG. 5, and/or machine-learning model 702 of FIG. 7.

An input layer 1202 includes input data. In one illustrative example, input layer 1202 can include data representing text, image data, audio data, video data, numerical data, etc. Neural network 1200 includes multiple hidden layers, for example, hidden layers 1206a, 1206b, through 1206n. The hidden layers 1206a, 1206b, through hidden layer 1206n include “n” number of hidden layers, where “n” is an integer greater than or equal to one. The number of hidden layers can be made to include as many layers as needed for the given application. Neural network 1200 further includes an output layer 1204 that provides an output resulting from the processing performed by the hidden layers 1206a, 1206b, through 1206n. In one illustrative example, output layer 1204 can generate text, image data, audio data, video data, numerical data, etc.

Neural network 1200 may be, or may include, a multi-layer neural network of interconnected nodes. Each node can represent a piece of information. Information associated with the nodes is shared among the different layers and each layer retains information as information is processed. In some cases, neural network 1200 can include a feed-forward network, in which case there are no feedback connections where outputs of the network are fed back into itself. In some cases, neural network 1200 can include a recurrent neural network, which can have loops that allow information to be carried across nodes while reading in input.

Information can be exchanged between nodes through node-to-node interconnections between the various layers. Nodes of input layer 1202 can activate a set of nodes in the first hidden layer 1206a. For example, as shown, each of the input nodes of input layer 1202 is connected to each of the nodes of the first hidden layer 1206a. The nodes of first hidden layer 1206a can transform the information of each input node by applying activation functions to the input node information. The information derived from the transformation can then be passed to and can activate the nodes of the next hidden layer 1206b, which can perform their own designated functions. Example functions include convolutional, up-sampling, data transformation, and/or any other suitable functions. The output of the hidden layer 1206b can then activate nodes of the next hidden layer, and so on. The output of the last hidden layer 1206n can activate one or more nodes of the output layer 1204, at which an output is provided. In some cases, while nodes (e.g., node 1208) in neural network 1200 are shown as having multiple output lines, a node has a single output and all lines shown as being output from a node represent the same output value.

In some cases, each node or interconnection between nodes can have a weight that is a set of parameters derived from the training of neural network 1200. Once neural network 1200 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1200 to be adaptive to inputs and able to learn as more and more data is processed.

Neural network 1200 may be pre-trained to process the features from the data in the input layer 1202 using the different hidden layers 1206a, 1206b, through 1206n in order to provide the output through the output layer 1204. In an example in which neural network 1200 is used to identify features in images, neural network 1200 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1200 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1200 is trained well enough so that the weights of the layers are accurately tuned.

For the example of identifying objects in images, the forward pass can include passing a training image through neural network 1200. The weights are initially randomized before neural network 1200 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1200, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1200 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1200 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 1200 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1200 can include any other deep network other than a CNN, such as an autoencoder, a deep belief nets (DBNs), a Recurrent Neural Networks (RNNs), among others.

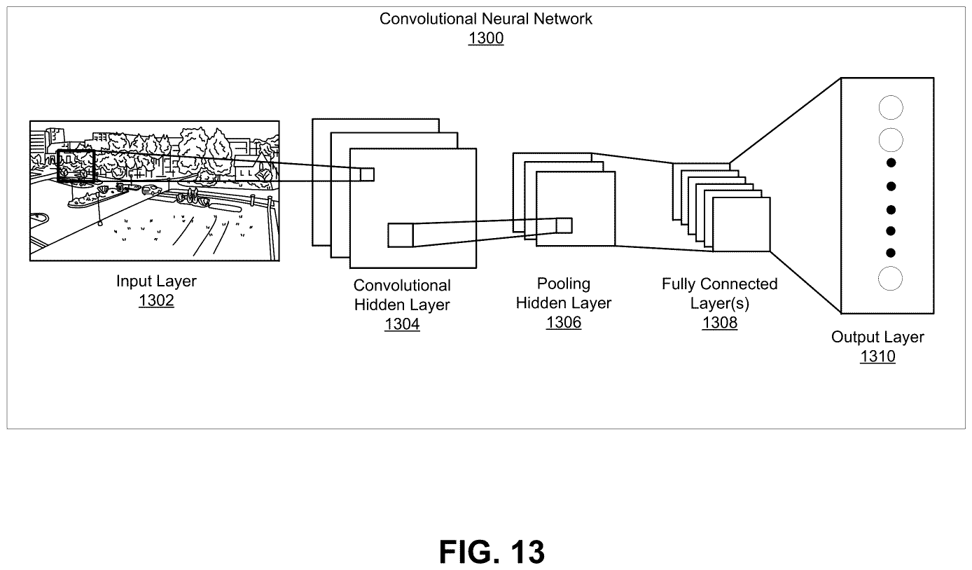

FIG. 13 is an illustrative example of a convolutional neural network (CNN) 1300. The input layer 1302 of the CNN 1300 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1304, an optional non-linear activation layer, a pooling hidden layer 1306, and fully connected layer 1308 (which fully connected layer 1308 can be hidden) to get an output at the output layer 1310. While only one of each hidden layer is shown in FIG. 13, one of ordinary skill will appreciate that multiple convolutional hidden layers, non-linear layers, pooling hidden layers, and/or fully connected layers can be included in the CNN 1300. As previously described, the output can indicate a single class of an object or can include a probability of classes that best describe the object in the image.

The first layer of the CNN 1300 can be the convolutional hidden layer 1304. The convolutional hidden layer 1304 can analyze image data of the input layer 1302. Each node of the convolutional hidden layer 1304 is connected to a region of nodes (pixels) of the input image called a receptive field. The convolutional hidden layer 1304 can be considered as one or more filters (each filter corresponding to a different activation or feature map), with each convolutional iteration of a filter being a node or neuron of the convolutional hidden layer 1304. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1304. Each connection between a node and a receptive field for that node learns a weight and, in some cases, an overall bias such that each node learns to analyze its particular local receptive field in the input image. Each node of the convolutional hidden layer 1304 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1304 is due to each node of the convolutional layer being applied to its corresponding receptive field. For example, a filter of the convolutional hidden layer 1304 can begin in the top-left corner of the input image array and can convolve around the input image. As noted above, each convolutional iteration of the filter can be considered a node or neuron of the convolutional hidden layer 1304. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1304. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1304.

The mapping from the input layer to the convolutional hidden layer 1304 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1304 can include several activation maps in order to identify multiple features in an image. The example shown in FIG. 13 includes three activation maps. Using three activation maps, the convolutional hidden layer 1304 can detect three different kinds of features, with each feature being detectable across the entire image.

In some examples, a non-linear hidden layer can be applied after the convolutional hidden layer 1304. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1300 without affecting the receptive fields of the convolutional hidden layer 1304.

The pooling hidden layer 1306 can be applied after the convolutional hidden layer 1304 (and after the non-linear hidden layer when used). The pooling hidden layer 1306 is used to simplify the information in the output from the convolutional hidden layer 1304. For example, the pooling hidden layer 1306 can take each activation map output from the convolutional hidden layer 1304 and generates a condensed activation map (or feature map) using a pooling function. Max-pooling is one example of a function performed by a pooling hidden layer. Other forms of pooling functions be used by the pooling hidden layer 1306, such as average pooling, L2-norm pooling, or other suitable pooling functions. A pooling function (e.g., a max-pooling filter, an L2-norm filter, or other suitable pooling filter) is applied to each activation map included in the convolutional hidden layer 1304. In the example shown in FIG. 13, three pooling filters are used for the three activation maps in the convolutional hidden layer 1304.

In some examples, max-pooling can be used by applying a max-pooling filter (e.g., having a size of 2×2) with a stride (e.g., equal to a dimension of the filter, such as a stride of 2) to an activation map output from the convolutional hidden layer 1304. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1304 having a dimension of 24×24 nodes, the output from the pooling hidden layer 1306 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1300.

The final layer of connections in the network is a fully-connected layer that connects every node from the pooling hidden layer 1306 to every one of the output nodes in the output layer 1310. Using the example above, the input layer includes 28×28 nodes encoding the pixel intensities of the input image, the convolutional hidden layer 1304 includes 3×24×24 hidden feature nodes based on application of a 5×5 local receptive field (for the filters) to three activation maps, and the pooling hidden layer 1306 includes a layer of 3×12×12 hidden feature nodes based on application of max-pooling filter to 2×2 regions across each of the three feature maps. Extending this example, the output layer 1310 can include ten output nodes. In such an example, every node of the 3×12×12 pooling hidden layer 1306 is connected to every node of the output layer 1310.

The fully connected layer 1308 can obtain the output of the previous pooling hidden layer 1306 (which should represent the activation maps of high-level features) and determines the features that most correlate to a particular class. For example, the fully connected layer 1308 can determine the high-level features that most strongly correlate to a particular class and can include weights (nodes) for the high-level features. A product can be computed between the weights of the fully connected layer 1308 and the pooling hidden layer 1306 to obtain probabilities for the different classes. For example, if the CNN 1300 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1310 can include an M-dimensional vector (in the prior example, M=10). M indicates the number of classes that the CNN 1300 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 14 illustrates an example computing-device architecture 1400 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1400 may include, implement, or be included in any or all of system 300 of FIG. 3, system 500 of FIG. 5, system 700 of FIG. 7, and/or other devices, modules, or systems described herein. Additionally or alternatively, computing-device architecture 1400 may be configured to perform process 400 of FIG. 4, process 600 of FIG. 6, process 800 of FIG. 8, process 900 of FIG. 9, process 1000 of FIG. 10, process 1100 of FIG. 11, and/or other process described herein.

The components of computing-device architecture 1400 are shown in electrical communication with each other using connection 1412, such as a bus. The example computing-device architecture 1400 includes a processing unit (CPU or processor) 1402 and computing device connection 1412 that couples various computing device components including computing device memory 1410, such as read only memory (ROM) 1408 and random-access memory (RAM) 1406, to processor 1402.

Computing-device architecture 1400 can include a cache of high-speed memory connected directly with, in close proximity to, or integrated as part of processor 1402. Computing-device architecture 1400 can copy data from memory 1410 and/or the storage device 1414 to cache 1404 for quick access by processor 1402. In this way, the cache can provide a performance boost that avoids processor 1402 delays while waiting for data. These and other modules can control or be configured to control processor 1402 to perform various actions. Other computing device memory 1410 may be available for use as well. Memory 1410 can include multiple different types of memory with different performance characteristics. Processor 1402 can include any general-purpose processor and a hardware or software service, such as service 1 1416, service 2 1418, and service 3 1420 stored in storage device 1414, configured to control processor 1402 as well as a special-purpose processor where software instructions are incorporated into the processor design. Processor 1402 may be a self-contained system, containing multiple cores or processors, a bus, memory controller, cache, etc. A multi-core processor may be symmetric or asymmetric.

To enable user interaction with the computing-device architecture 1400, input device 1422 can represent any number of input mechanisms, such as a microphone for speech, a touch-sensitive screen for gesture or graphical input, keyboard, mouse, motion input, speech and so forth. Output device 1424 can also be one or more of a number of output mechanisms known to those of skill in the art, such as a display, projector, television, speaker device, etc. In some instances, multimodal computing devices can enable a user to provide multiple types of input to communicate with computing-device architecture 1400. Communication interface 1426 can generally govern and manage the user input and computing device output. There is no restriction on operating on any particular hardware arrangement and therefore the basic features here may easily be substituted for improved hardware or firmware arrangements as they are developed.

Storage device 1414 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1406, read only memory (ROM) 1408, and hybrids thereof. Storage device 1414 can include services 1416, 1418, and 1420 for controlling processor 1402. Other hardware or software modules are contemplated. Storage device 1414 can be connected to the computing device connection 1412. In one aspect, a hardware module that performs a particular function can include the software component stored in a computer-readable medium in connection with the necessary hardware components, such as processor 1402, connection 1412, output device 1424, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for modifying a binary file, the apparatus comprising: at least one memory; and at least one processor coupled to the at least one memory and configured to: obtain a plurality of update weights to apply to respective update layers of a plurality of update layers of an executable file representative of a machine-learning model; extract a plurality of weights from the executable file; divide the plurality of weights into a plurality of chunks; identify a respective chunk offset relative to a reference point in the executable file for each chunk of the plurality of chunks; transform update weights of each update layer of the plurality of update layers to generate respective transformed weights; chunk the respective transformed weights to generate transformed chunks for each update layer; identify an update offset relative to the reference point in the executable file for each transformed chunk of the transformed chunks of each update layer based on the respective chunk offset identified for each chunk; chunk each weight of the plurality of update weights to generate a plurality of updated chunks; transform each chunk of the plurality of updated chunks to generate a plurality of transformed chunks; and insert the plurality of transformed chunks into the executable file based on the identified update offsets to generate an updated executable file.

Aspect 2. The apparatus of aspect 1, wherein the at least one processor is configured to execute the updated executable file.

Aspect 3. The apparatus of any one of aspects 1 or 2, wherein, to transform a chunk, the at least one processor is configured to at least one of: pad a value of the chunk; tile a matrix of values of the chunk; reorder values of the chunk; or partition values of the chunk.

Aspect 4. The apparatus of any one of aspects 1 to 3, wherein the machine-learning model comprises a graph neural network.

Aspect 5. The apparatus of any one of aspects 1 to 4, wherein the executable file comprises an executable binary file.

Aspect 6. An apparatus for storing an executable file, the apparatus comprising: at least one memory; and at least one processor coupled to the at least one memory and configured to: transform at least a portion of a binary file representative of a machine-learning model into a transformed binary file for execution; while transforming the machine-learning model, record operations performed on weights of the machine-learning model as a graph and storing an ordering of inputs to a constant graph; convert the graph into the constant graph for execution; extract data from the machine-learning model to generate a reduced model; and store the reduced model, the constant graph, and the ordering as a context binary file.

Aspect 7. The apparatus of aspect 6, wherein: the inputs to the constant graph comprise nodes of the machine-learning model including constant data of the machine-learning model; and the ordering of inputs to the constant graph comprises an order in which the nodes of the machine-learning model are added to the machine-learning model.

Aspect 8. The apparatus of any one of aspects 6 or 7, wherein the at least one processor is configured to provide the context binary file to a device that is configured to extract the transformed binary file.

Aspect 9. The apparatus of aspect 8, wherein the device is further configured to update the transformed binary file.

Aspect 10. The apparatus of any one of aspects 8 or 9, wherein the device is further configured to execute the transformed binary file.

Aspect 11. The apparatus of any one of aspects 8 to 10, wherein the device is further configured to provide the transformed binary file to another device for execution.

Aspect 12. The apparatus of any one of aspects 8 to 11, wherein, to transform a chunk, the at least one processor is configured to at least one of: pad a value of the chunk; tile a matrix of values of the chunk; reorder values of the chunk; or partition values of the chunk.

Aspect 13. The apparatus of any one of aspects 6 to 12, wherein the machine-learning model comprises a graph neural network.

Aspect 14. The apparatus of any one of aspects 6 to 13, wherein the executable file comprises an executable binary file.

Aspect 15. An apparatus for obtaining an executable file, the apparatus comprising: at least one memory; and at least one processor coupled to the at least one memory and configured to: separate a context binary file to obtain a transformed binary file representative of a machine-learning model transformed for execution on a backend, a constant graph, and a mapping; arrange data from a machine-learning-model file according to the mapping; execute the constant graph using the arranged data to generate an output; and generate an updated binary file based on the transformed binary file and the output.

Aspect 16. The apparatus of aspect 15, wherein the at least one processor is configured to execute the updated binary file.

Aspect 17. The apparatus of any one of aspects 15 or 16, wherein the at least one processor is configured to provide the transformed binary file to another device for execution.

Aspect 18. The apparatus of any one of aspects 15 to 17, wherein the transformed binary file has been generated using at least one of: padding a value of a chunk of a weight of the machine-learning model represented by the transformed binary file; tiling a matrix of values of the chunk; reordering values of the chunk; or partitioning values of the chunk.

Aspect 19. The apparatus of any one of aspects 15 to 18, wherein the machine-learning model comprises a graph neural network.

Aspect 20. The apparatus of any one of aspects 15 to 19, wherein the executable file comprises an executable binary file.

Aspect 21. A method for modifying a binary file, the method comprising: obtaining a plurality of update weights to apply to respective update layers of a plurality of update layers of an executable file representative of a machine-learning model; extracting a plurality of weights from the executable file; dividing the plurality of weights into a plurality of chunks; identifying a respective chunk offset relative to a reference point in the executable file for each chunk of the plurality of chunks; transforming update weights of each update layer of the plurality of update layers to generate respective transformed weights; chunking the respective transformed weights to generate transformed chunks for each update layer; identifying an update offset relative to the reference point in the executable file for each transformed chunk of the transformed chunks of each update layer based on the respective chunk offset identified for each chunk; chunking each weight of the plurality of update weights to generate a plurality of updated chunks; transforming each chunk of the plurality of updated chunks to generate a plurality of transformed chunks; and inserting the plurality of transformed chunks into the executable file based on the identified update offsets to generate an updated executable file.

Aspect 22. The method of aspect 21, further comprising executing the updated executable file.

Aspect 23. The method of any one of aspects 21 or 22, wherein transforming a chunk comprises at least one of: padding a value of the chunk; tiling a matrix of values of the chunk; reordering values of the chunk; or partitioning values of the chunk.

Aspect 24. The method of any one of aspects 21 to 23, wherein the machine-learning model comprises a graph neural network.

Aspect 25. The method of any one of aspects 21 to 24, wherein the executable file comprises an executable binary file.

Aspect 26. A method for storing an executable file, the method comprising: transforming at least a portion of a binary file representative of a machine-learning model into a transformed binary file for execution; while transforming the machine-learning model, recording operations performed on weights of the machine-learning model as a graph and storing an ordering of inputs to a constant graph; converting the graph into the constant graph for execution; extracting data from the machine-learning model to generate a reduced model; and storing the reduced model, the constant graph, and the ordering as a context binary file.

Aspect 27. The method of aspect 26, wherein: the inputs to the constant graph comprise nodes of the machine-learning model including constant data of the machine-learning model; and the ordering of inputs to the constant graph comprises an order in which the nodes of the machine-learning model are added to the machine-learning model.

Aspect 28. The method of any one of aspects 26 or 27, further comprising providing the context binary file to a device that is configured to extract the transformed binary file and

Aspect 29. The method of aspect 28, wherein the device is further configured to update the transformed binary file.

Aspect 30. The method of any one of aspects 28 or 29, wherein the device is further configured to execute the transformed binary file.

Aspect 31. The method of any one of aspects 28 to 30, wherein the device is further configured to provide the transformed binary file to another device for execution.

Aspect 32. The method of any one of aspects 26 to 31, wherein transforming a chunk comprises at least one of: padding a value of the chunk; tiling a matrix of values of the chunk; reordering values of the chunk; or partitioning values of the chunk.

Aspect 33. The method of any one of aspects 26 to 32, wherein the machine-learning model comprises a graph neural network.

Aspect 34. The method of any one of aspects 26 to 33, wherein the executable file comprises an executable binary file.

Aspect 35. A method for obtaining an executable file, the method comprising: separating a context binary file to obtain a transformed binary file representative of a machine-learning model transformed for execution on a backend, a constant graph, and a mapping; arranging data from a machine-learning-model file according to the mapping; executing the constant graph using the arranged data to generate an output; and generating an updated binary file based on the transformed binary file and the output.

Aspect 36. The method of aspect 35, further comprising executing the updated binary file.

Aspect 37. The method of any one of aspects 35 or 36, wherein the transformed binary file has been generated using at least one of: padding a value of a chunk of a weight of the machine-learning model represented by the transformed binary file; tiling a matrix of values of the chunk; reordering values of the chunk; or partitioning values of the chunk.

Aspect 38. The method of any one of aspects 35 to 37, wherein the machine-learning model comprises a graph neural network.

Aspect 39. The method of any one of aspects 35 to 38, wherein the executable file comprises an executable binary file.

Aspect 40. The method of any one of aspects 35 to 39, further comprising providing the transformed binary file to another device for execution.

Aspect 41. A non-transitory computer-readable storage medium having stored thereon instructions that, when executed by at least one processor, cause the at least one processor to perform operations according to any of aspects 21 to 40

Aspect 42. An apparatus, the apparatus comprising one or more means for perform operations according to any of aspects 21 to 40.

What is claimed is:

1. An apparatus for modifying a binary file, the apparatus comprising:
at least one memory; and
at least one processor coupled to the at least one memory and configured to:
obtain a plurality of update weights to apply to respective update layers of a plurality of update layers of an executable file representative of a machine-learning model;
extract a plurality of weights from the executable file;
divide the plurality of weights into a plurality of chunks;
identify a respective chunk offset relative to a reference point in the executable file for each chunk of the plurality of chunks;
transform update weights of each update layer of the plurality of update layers to generate respective transformed weights;
chunk the respective transformed weights to generate transformed chunks for each update layer;
identify an update offset relative to the reference point in the executable file for each transformed chunk of the transformed chunks of each update layer based on the respective chunk offset identified for each chunk;
chunk each weight of the plurality of update weights to generate a plurality of updated chunks;
transform each chunk of the plurality of updated chunks to generate a plurality of transformed chunks; and
insert the plurality of transformed chunks into the executable file based on the identified update offsets to generate an updated executable file.

2. The apparatus of claim 1, wherein the at least one processor is configured to execute the updated executable file.

3. The apparatus of claim 1, wherein, to transform a chunk, the at least one processor is configured to at least one of:
pad a value of the chunk;
tile a matrix of values of the chunk;
reorder values of the chunk; or
partition values of the chunk.

4. The apparatus of claim 1, wherein the machine-learning model comprises a graph neural network.

5. The apparatus of claim 1, wherein the executable file comprises an executable binary file.

6. An apparatus for storing an executable file, the apparatus comprising:
at least one memory; and
at least one processor coupled to the at least one memory and configured to:
transform at least a portion of a binary file representative of a machine-learning model into a transformed binary file for execution;
while transforming the machine-learning model, record operations performed on weights of the machine-learning model as a graph and store an ordering of inputs to a constant graph;
convert the graph into the constant graph for execution;
extract data from the machine-learning model to generate a reduced model; and
store the reduced model, the constant graph, and the ordering as a context binary file.

7. The apparatus of claim 6, wherein:
the inputs to the constant graph comprise nodes of the machine-learning model including constant data of the machine-learning model; and
the ordering of inputs to the constant graph comprises an order in which the nodes of the machine-learning model are added to the machine-learning model.

8. The apparatus of claim 6, wherein the at least one processor is configured to provide the context binary file to a device that is configured to extract the transformed binary file.

9. The apparatus of claim 8, wherein the device is further configured to update the transformed binary file.

10. The apparatus of claim 8, wherein the device is further configured to execute the transformed binary file.

11. The apparatus of claim 8, wherein the device is further configured to provide the transformed binary file to another device for execution.

12. The apparatus of claim 6, wherein, to transform a chunk, the at least one processor is configured to at least one of:
pad a value of the chunk;
tile a matrix of values of the chunk;
reorder values of the chunk; or
partition values of the chunk.

13. The apparatus of claim 6, wherein the machine-learning model comprises a graph neural network.

14. The apparatus of claim 6, wherein the executable file comprises an executable binary file.

15. An apparatus for obtaining an executable file, the apparatus comprising:
at least one memory; and
at least one processor coupled to the at least one memory and configured to:
separate a context binary file to obtain a transformed binary file representative of a machine-learning model transformed for execution on a backend, a constant graph, and a mapping;
arrange data from a machine-learning-model file according to the mapping;
execute the constant graph using the arranged data to generate an output; and
generate an updated binary file based on the transformed binary file and the output.

16. The apparatus of claim 15, wherein the at least one processor is configured to execute the updated binary file.

17. The apparatus of claim 15, wherein the at least one processor is configured to provide the transformed binary file to another device for execution.

18. The apparatus of claim 15, wherein the transformed binary file has been generated using at least one of:
padding a value of a chunk of a weight of the machine-learning model represented by the transformed binary file;
tiling a matrix of values of the chunk;
reordering values of the chunk; or
partitioning values of the chunk.

19. The apparatus of claim 15, wherein the machine-learning model comprises a graph neural network.

20. The apparatus of claim 15, wherein the executable file comprises an executable binary file.
